(19) United States
(12) Patent Application Publication
(10) Pub. No.: US 2022/0153210 A1
(43) Pub. Date: May 19, 2022

(54) LIGHTWEIGHT PERFORATED FILMS AND THEIR USE IN ACOUSTICAL INSULATORS FOR INCREASED SOUND ABSORPTION

(71) Applicant: Molded Acoustical Products of Easton, Inc., Easton, PA (US)

(72) Inventor: Jakub Daniszewski, Ocala, FL (US)

(73) Assignee: Molded Acoustical Products of Easton, Inc., Easton, PA (US)

(21) Appl. No.: 17/527,580

(22) Filed: Nov. 16, 2021

Related U.S. Application Data
(60) Provisional application No. 63/115,670, filed on Nov. 19, 2020.

(51) Int. Cl. B60R 13/08; C08J 9/36; G10K 11/168; B32B 5/02; B32B 3/26; B32B 5/18; B32B 5/24; B32B 27/40; B32B 27/12; B32B 27/32; B32B 27/36; B32B 27/30

(52) U.S. Cl. CPC B60R 13/0838; B32B 2605/00; G10K 11/168; B60R 13/0876; B60R 13/0869; B32B 5/028; B32B 3/266; B32B 5/18; B32B 5/245; B32B 27/40; B32B 27/12; B32B 27/32; B32B 27/36; B32B 27/306; C08J 2375/04; B32B 2307/102; B32B 2262/101; B32B 2262/0276; B32B 2262/062; B32B 2266/0278; B32B 2305/38; C08J 9/36

(57) ABSTRACT

A sound absorber/insulator in a motor vehicle is constructed of outer layer nonwoven scrims, perforated films, and a fill material core, which are typically fibers or foams. Fibers could be of a nonorganic nature such as glass, or an organic one like polyester or cotton. Foams could be of open cell polyurethane chemistry. The materials are enveloped in a thermoforming process wherein all layers are substantially adhered to each other. The fill material is responsible for sound attenuation whereby a higher weight input provides additional attenuation benefit. Specialized technical nonwoven scrims can also be used to enhance the sound attenuation where required. Increasing absorption properties by adding weight or using highly technical nonwovens is costly and results in a weight penalty. Perforated films of certain thicknesses, hole sizes, and hole densities significantly enhance sound attenuation properties of an absorber and do so with no changes to the manufacturing process, a minimal increase in weight, and at a substantially lower cost. The films can be positioned in different locations throughout an insulator, depending on absorption requirements.

### CROSS REFERENCE TO RELATED APPLICATION

This application claims the priority of U.S. provisional application 63/115,670, filed Nov. 19, 2020.

### FIELD OF THE INVENTION

The present invention relates to the field of acoustical insulators and sound absorbers based on a perforated film, that is confined within an envelope of scrims and/or sound absorbing fill materials during the formation of the insulator. The envelope assumes a shape when packed with scrim, film, and absorbing material, and is placed as a unit in a void of substantially complementary shape of the sheet metal during assembly. An improved insulator is produced to maximize sound absorption that is emitted by the engine, motor, mechanical and electrical components, road, and wind noise.

### BACKGROUND OF THE INVENTION

Sound insulators, absorbers and the like are placed along sound paths of vehicles to reduce noise emitted by various mechanical and electrical components, as well as road and wind noise. An insulator typically defines an area adjacent to sheet metal that attenuates sound vibrations. When designing an insulator, attention is paid to achieving maximum sound absorption rates within a finite available space. Insulators are also designed to be as light as possible, thus helping achieve curb weight targets that aim to help the average fuel economy of the vehicle.

An insulator along the sound path comprises resilient forms, typically fibers or foams, that are displaceable with sound pressure variations at audible frequencies, thereby damping the amplitude of sounds emitted by the sound sources. The insulator needs to be rigid enough to support its own weight in one way or another, so as to not sag or become loose from the sheet metal.

In order to attenuate noise, the fill material of the insulator needs to be arranged as a porous mass in which acoustic waves can propagate, while filling out one or more shaped voids within the insulator. One appropriate material for insulator fill is a polyurethane open cell foam. Another suitable material is a fiber blanket that is premixed with thermo-reactive binders. Provisions are advantageous to conform and confine the fill material to the shape of the void in the insulator during an assembly. Assembly typically involves thermoforming fill material in a hydraulic or pneumatic press, using heat and pressure to release enough thermal and mechanical energy so as to bind the cells or fibers to each other.

Fill materials are normally faced on both sides with lightweight nonwoven scrims. Scrims are generally so lightweight and porous that they do not alter sound absorbing properties of the underlying fill material. Some specialized scrims known as Air Flow Resistant (AFR) scrims do enhance absorption properties, and are currently used on several applications. In order for the AFR scrims to function properly, they must be located toward the side from which the sound source is emitted.

A widely used technique for increasing sound absorption within a defined envelope is to increase the weight of the fill material, alone or in combination with AFR scrims. Adding weight increases density of the insulator, which in turn provides better sound attenuation in the lower frequency range. This frequency range tends to be the most difficult to control.

Another option for enhancing sound attenuation is to increase thickness of the insulator. While the end results are beneficial, this is generally difficult to implement due to limitations in available space. These constraints are especially prevalent within the confines of a vehicle. Fill materials normally come in predetermined thicknesses that are directly proportional to their weight. Therefore, thicker insulators are also burdened by heavier weight that is required in order to fill their envelope.

While the above solutions provide mostly acceptable results, besides adding weight, space requirements, or both, they have one common factor: They all add very significant cost to such insulators. Increasing weight or adding AFR scrim alone can easily increase the cost of a part by about 50%. Combining both into the design could further increase the part cost.

### SUMMARY OF THE INVENTION

The present invention relates to the use of a low weight and low cost perforated or microperforated film in combination with lightweight and low cost nonwoven scrims, or in combination with one or more layers of fill material, in order to provide significant reduction in cost, weight, or both, while functioning at the same performance level as the more costly designs described in the previous paragraphs. The added cost and weight of perforated films is insignificant as compared to other techniques described within.

### BRIEF DESCRIPTION OF THE DRAWINGS

FIG. 1 is a sample diagram of a small hole, low density straight perforation pattern. This is not an ideal pattern.

FIG. 2 is a sample diagram of a small hole, medium density staggered perforation pattern. This is a more preferable pattern.

FIG. 3 is a sample diagram of a small hole, high density staggered perforation pattern. This is the most desirable pattern.

FIG. 4 is an assembly view of an insulator with the perforated film positioned toward the front side (sound source) in between the scrim and fill material, as described below.

FIG. 5 is an assembly view of an insulator with the perforated film positioned between two layers of the fill material (as a septum), as described below.

FIG. 6 is an assembly view of an insulator with the perforated film positioned toward the back side (with an air gap behind) in between the fill material and scrim, as described below.

FIG. 7 is a graph of sound absorption test results for same 610 gsm weight fiberglass fill and 20 mm thick test specimens, but one with the perforated film located toward the front side and the other without a film.

FIG. 8 is a graph of sound absorption test results for same 810 gsm weight fiberglass fill and 20 mm thick test specimens, but one with the perforated film located toward the front side and the other without a film.

FIG. 9 is a graph of sound absorption test results for same 1620 gsm weight fiberglass fill and 20 mm thick test specimens, but one with the perforated film located between the layers of fiberglass blanket and the other without a film.

FIG. 10 is a graph of sound absorption test results for same 810 gsm weight fiberglass fill and 25 mm thick test specimens, but one with the perforated film located toward the front side and the other without a film.

FIG. 11 is a graph of sound absorption test results for same 1020 gsm weight fiberglass fill and 25 mm thick test specimens, but one with the perforated film located toward the front side and the other without a film.

FIG. 12 is a graph of sound absorption test results for same 1620 gsm weight fiberglass fill and 25 mm thick test specimens, but one with the perforated film located between the layers of fiberglass blanket and the other without a film.

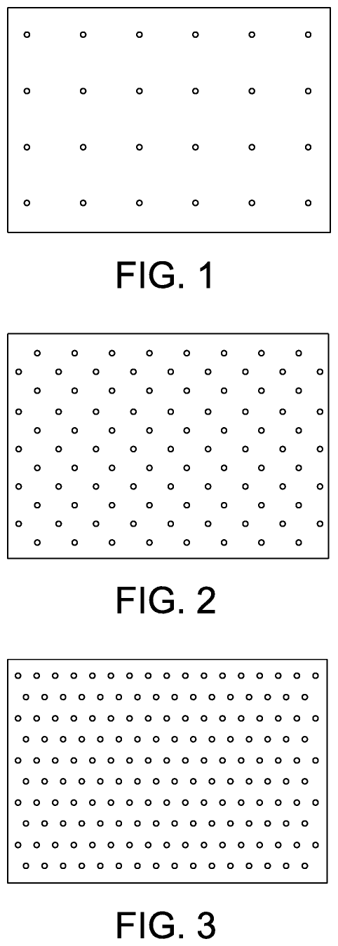

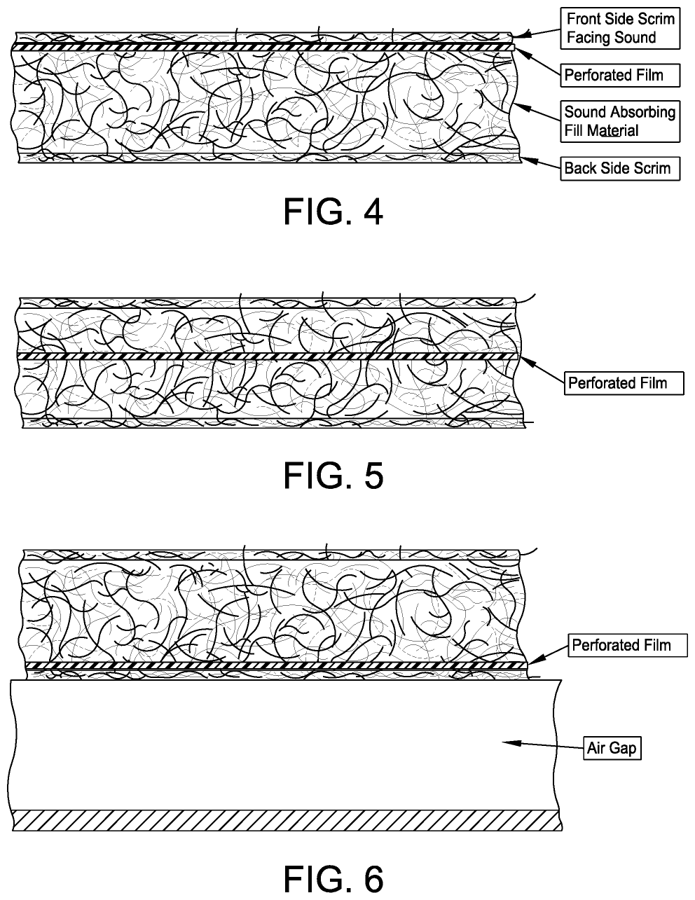

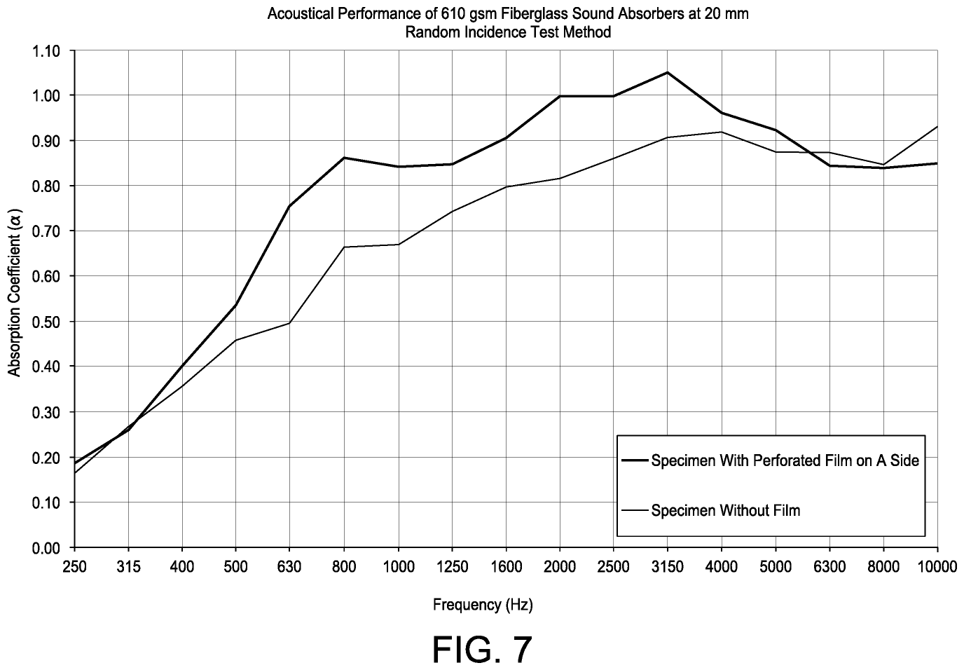

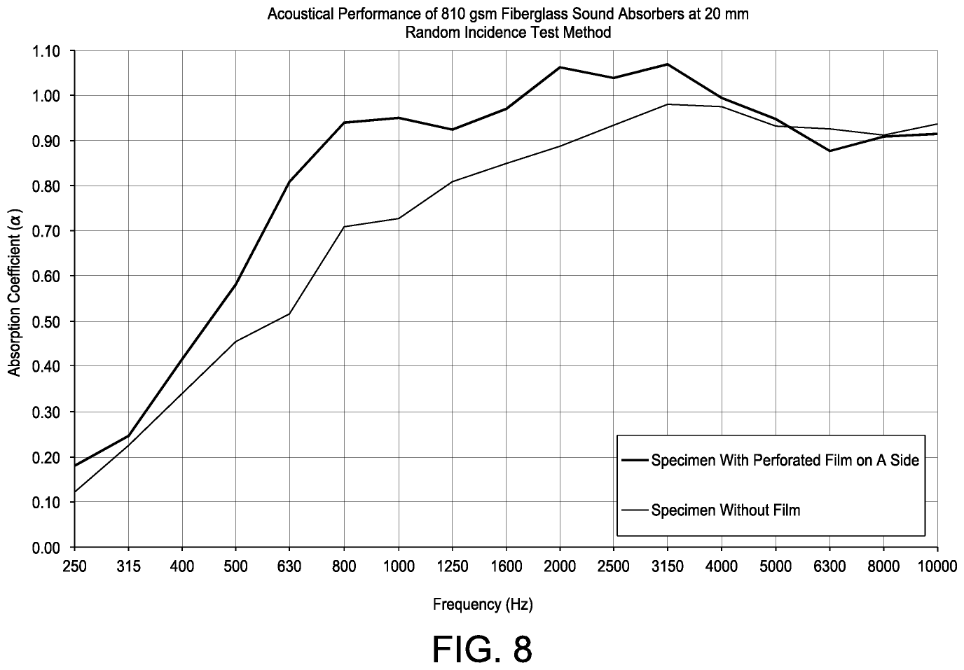

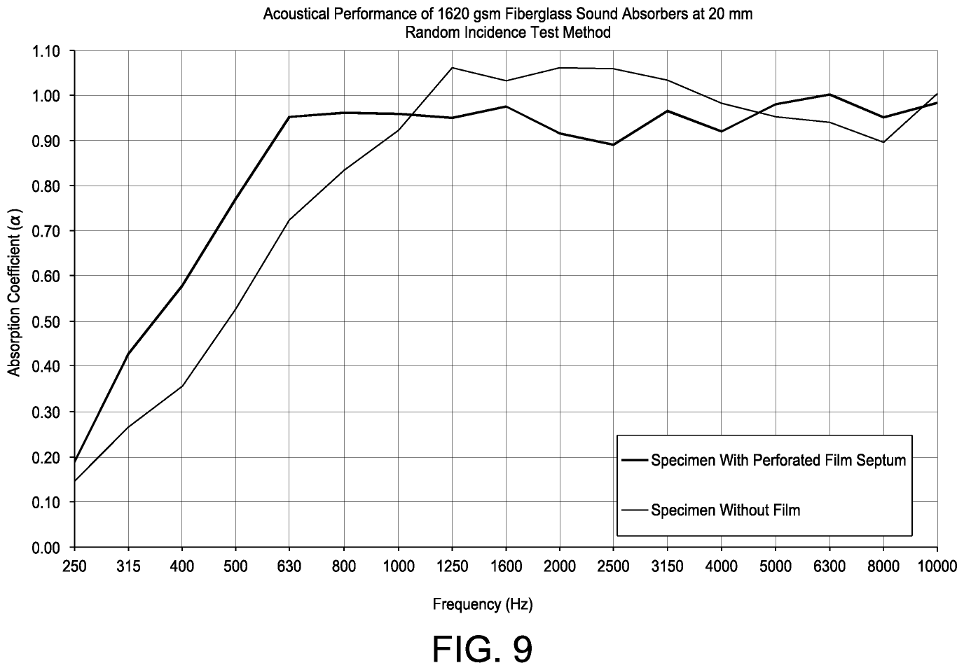

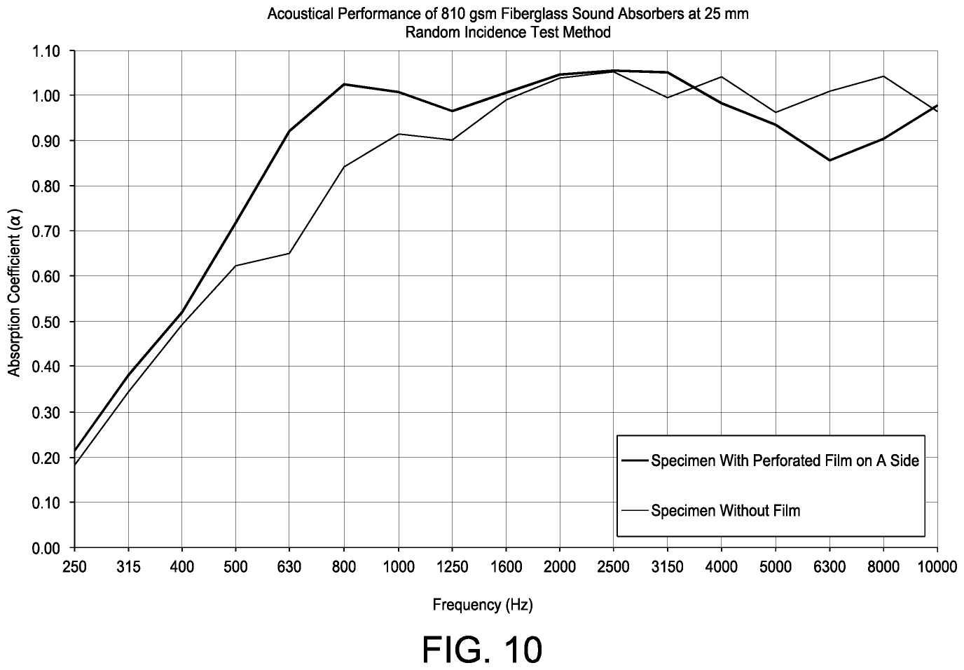

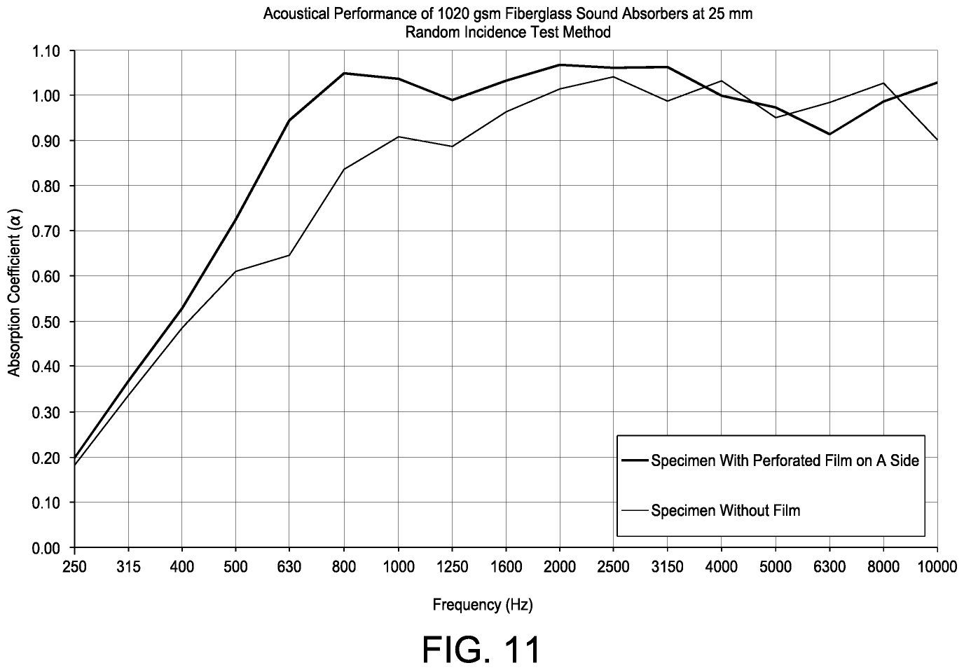

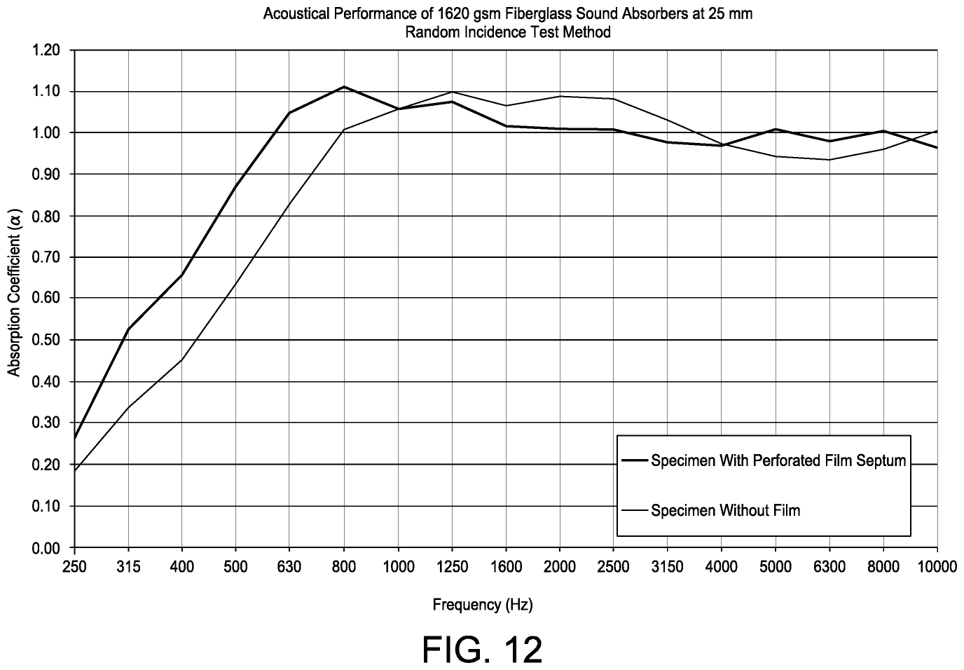

### DETAILED DESCRIPTION OF THE INVENTION

Most common perforated or microperforated films are made from thermoplastic polymers, specifically polyethylene (PE) or polypropylene (PP). Both enjoy low cost characteristics, are easy to process, and provide similar performance improvements. Thicknesses can range from about 0.2 mils to 20 mils. A preferred range is about 0.5 mils to 5 mils. A thickness of about 1 mil is particularly preferred. Other polymeric films of similar thickness could be used as well, such as polyester (PET), vinyls (EVA and others), thermoplastic olefins (TPO), acetate, and other plastic films. In addition, foil films such as aluminum and copper work as well, although their costs are vastly inferior to that of PE or PP.

Insulators generally consist of a front side nonwoven scrim on the surface that faces the sound source, one or more layers of fill material that act as a sound absorber, and a back side nonwoven scrim.

Another object of the present invention is the positioning of the perforated film in relation to scrims and fill material. The location of films can easily be modified depending on what frequencies are being targeted to increase sound absorption of a given part. Positioning film under the front side scrim (toward the sound source) would result in an overall improvement in sound absorption throughout the entire frequency range. Locating film in between layers of fill material, as a septum, results in a major improvement of the low frequency absorption while maintaining higher frequency performance. In addition, placing film under the back scrim in combination with an air gap would increase performance in the low to mid-frequency ranges.

Absorbers with perforated films can be used with or without the AFR scrims to further enhance the performance, depending on the relative positioning of the film and AFR scrim. Placing a film directly under the AFR scrim would not increase sound attenuation performance as much as it would if the film was placed between two or more layers of fill material, in conjunction with the AFR scrim being on the front surface. Films can be used in lieu of an AFR scrim as a method to maintain the performance of an AFR scrim, without adding considerable cost associated with the AFR scrims. Films can also be used with plain, lightweight nonwoven scrims and the same or similar fill material weight, in order to increase the sound absorption performance without adding significant cost. Alternatively, they can be used with a lower weight fill material to maintain equal acoustic performance, while providing reduced cost and lower weight benefits.

A further object of the present invention is the design of perforations or micro-perforations. The size of the perforations, density of the holes throughout the film, and the resulting overall open area greatly affects sound absorption properties. Open area generally ranges from 0.2% up to 20%. The preferred range is 0.5% to 10%. A particularly preferred range is 1% to 8%. This open area can be achieved with large perforations arranged in a small density; however, this arrangement is not recommended. Preferred arrangements consist of small to medium perforations arranged in a medium to large density. Perforations generally range from 0.002″ to 0.250″ in diameter. The preferred range is 0.005″ to 0.150″ in diameter. A particularly preferred range is 0.010″ to 0.100″ in diameter.

What is claimed is:

1. An acoustical insulator for placement in a void defined along a sound path, said acoustical insulator comprising an envelope of material including a perforated film, a nonwoven scrim and a fill material core.

2. The acoustical insulator as recited in claim 1, wherein the fill material core is comprised of fibers or foams.

3. The acoustical insulator as recited in claim 1, wherein the fibers are of a nonorganic or organic nature.

4. The acoustical insulator as recited in claim 2, wherein the fibers are selected from the group consisting of glass, polyester and/or cotton.

5. The acoustical insulator as recited in claim 2, wherein the foams are of open cell polyurethane chemistry.

6. The acoustical insulator as recited in claim 1, wherein the insulator maximizes sound absorption that is emitted by an engine, motor, mechanical and electrical components, road and wind noise.

7. The acoustical insulator as recited in claim 1, wherein an open area of the perforated film ranges from about 0.2% to 20% of the film surface.

8. The acoustical insulator as recited in claim 7, wherein an open area of the perforated film ranges from about 0.5% to 10% of the film surface.

9. The acoustical insulator as recited in claim 8, wherein an open area of the perforated film ranges from about 1% to 8% of the film surface.

10. The acoustical insulator as recited in claim 1, wherein perforations of the film are from about 0.002″ to 0.250″ in diameter.

11. The acoustical insulator as recited in claim 10, wherein perforations of the film are from about 0.005″ to 0.150″ in diameter.

12. The acoustical insulator as recited in claim 11, wherein perforations of the film are from about 0.010″ to 0.100″ in diameter.

13. A method of manufacturing an acoustical insulator for placement in a void defined along an exhaust path, which comprises providing an envelope of material including a perforated film, a nonwoven scrim and a fill material core.

14. The method as recited in claim 13, wherein the film is positioned under the scrim, thereby providing an improvement in sound absorption throughout an entire frequency range.

15. The method as recited in claim 13, wherein the film is positioned toward a sound source, under the front scrim.

16. The method as recited in claim 13, wherein the film is located between layers of fill material.

17. The method as recited in claim 14, wherein the film is located toward the back side under the back scrim in combination with an air gap.

18. The method as recited in claim 13, wherein the material is enveloped in a thermoforming process, whereby all layers are substantially adhered to each other.
